(19) United States
(12) Patent Application Publication
(10) Pub. No.: US 2026/0029980 A1
(43) Pub. Date: Jan. 29, 2026

(54) Mixed-Reality Theme Park System and Method of Operating Thereof

(71) Applicant: DoubleMe, Inc., Seoul (KR)

(72) Inventor: Heekwan Kim, Seoul (KR)

(21) Appl. No.: 18/781,050

(22) Filed: Jul. 23, 2024

(51) Int. Cl. G06F 3/14; G06F 3/01; G06T 15/20; G06T 19/00

(52) U.S. Cl. CPC G06F 3/1454; G06F 3/017; G06T 15/20; G06T 19/00

(57) ABSTRACT

A novel computerized theme park system provides an immersive mixed-reality (MR) theme park environment by projecting a user-selected thematic environment and objects on a large projection screen and by accommodating seamless bilateral user interactivity and object transfers between a projection-mapping environment controlled by the projection system and a private mixed-reality (MR) environment operated by the user's personal electronic device. This novel theme park system can also initiate a holographic transfer-out, an adoption, or a release of an object between the projection-mapping environment controlled by the projection system and the user's private MR environment controlled by the user's personal electronic device. Furthermore, the novel system also provides a real-time bilateral user interactivity with a projected environment and objects displayed on the projection screen by capturing, tracking, and reacting to defined user gestures or other user-activated commands in front of the projected environment and objects.

### BACKGROUND OF THE INVENTION

The present invention generally relates to holographic and projection-mapped object mixed-reality visualizations provided by computer graphics generation. In particular, the present invention relates to a computer graphics-generated mixed-reality theme park system capable of projecting interactive and mapped objects and scenery on one or more walls, while enabling transfer-in and transfer-out of computerized objects between a projection-mapping environment and a user's separate mixed-reality environment in the user's personal electronic device. Furthermore, the present invention also relates to a method of operating the mixed-reality theme park system to accommodate interactivity of projection-mapped objects and projected scenery with users and the transfer-in and the transfer-out of computerized objects between the projection-mapping environment and the user's separate mixed-reality environment.

Continuous evolution and innovation in projection display technology have enabled large-screen projection mapping applications for advertising and visual art exhibits in recent years. Projection mapping is a projection technique configured to transform various locations (e.g. a large wall in a room, a building sidewall, a large irregularly-shaped object, etc.) into display surfaces for video projection. By utilizing specialized projection-mapping software, a targeted location is spatially-mapped on virtual coordinates and utilized as a projection surface representing various themes and environments, such as artistic and/or architectural contents in motion, or natural landscapes in motion (e.g. a mountainous habitat, a desert ecosystem, an oceanic underwater environment, an Artic iceberg, an outer space, etc.).

The spatial-mapping and the projection of various themes and environments on the targeted location are intended to mimic the sense of real-life physical visualization of the projected themes and environments for viewers. The specialized projection-mapping software is capable of controlling the projector to provide overlays of any desired images of objects onto the surface of the targeted location. In existing projection-mapping applications today, this overlaying technique is employed by advertisers and artists to add extra dimensions to their exhibits, which may provide desirable optical illusions of movement onto each targeted location. The resulting projection-mapped video on a targeted location is also often combined with audio to provide a vivid multimedia experience on the targeted location, which is often a large wall inside or outside of a building structure. Unfortunately, existing large-screen projection-mapping applications commercially deployed today are typically unilateral presentations of multimedia contents on large vertical walls or screens to viewers, and lack the ability to accommodate immersive real-time viewer interactions with projected multimedia exhibits. The insufficient avenue for real-time viewer interactions with exhibits in conventional projection-mapping applications fundamentally restricts the commercial usefulness of projection-mapping techniques to a narrow genre of visual exhibitions (e.g. visual arts and advertising).

In another field of technological developments, virtual reality (VR) and augmented reality (AR) applications are gaining popularity and relevance in electronic user applications in recent years. For example, VR headsets for computers and portable devices are designed to provide interactive and stereoscopic gaming experiences, training simulations, and educational environments for users wearing the VR headsets. In another example, augmented reality (AR) mobile applications are designed to add texts, descriptions, or added (i.e. “augmented”) digitized materials to physical objects if a user wears AR goggles or utilizes AR-compatible mobile applications executed in portable devices. For one of ordinary skill in the art, virtual reality (VR) refers to a completely computer-generated synthetic environment with no direct correlations to a real physical space or a real physical object, while augmented reality (AR) refers to descriptive digital materials that are displayed next to a machine-recognized real physical object to add or “augment” more information to the physical reality. Furthermore, a recent evolution of VR and AR applications has resulted in an innovative intermixture of computer-generated lifelike holographic objects and real objects that are synchronized and correlated to a particular physical space (i.e. as a “mixed-reality” (MR) environment) for immersive user interactions during the user's visit to the particular physical space. Although mixed-reality (MR) applications have been created and deployed in limited and experimental capacity for tourism of museums, exhibits, and other landmarks, they have not been utilized synergistically in context of large-screen projection-mapping applications.

Therefore, it may be advantageous to devise a novel interactive projection-mapped visualization system that can project desired moving images of environments and objects on a large surface at a targeted location (e.g. a large vertical wall, a sidewall of a building, etc.), wherein the projected moving images of objects can be transferred out (i.e. “popped out”) of the projection-mapping environment to become three-dimensional (3D) holograms in a mixed-reality (MR) environment operated by a user's separate and personal electronic device (e.g. an MR headset, a smart phone, etc.).

Moreover, it may also be advantageous to devise a novel interactive projection-mapped visualization system that accommodates seamless transfers of synthetic graphical objects between a projection-mapping environment and a mixed-reality environment operated by a user's separate and personal electronic device during the user's visualization of the projection-mapping environment on a large surface at a targeted location.

In addition, it may also be advantageous to devise a novel interactive projection-mapped visualization system that provides seamless bilateral user interactivity with a projected environment and objects displayed on a large surface at a targeted location by capturing, tracking, and reacting to defined user gestures in front of the projected environment and objects.

Furthermore, it may also be advantageous to devise a novel interactive projection-mapped visualization system that provides an immersive mixed-reality theme park environment by projecting a user-selected thematic environment and objects on a large surface at a targeted location, and by accommodating seamless bilateral user interactivity and object transfers between a projection-mapping environment and a mixed-reality environment operated by the user's separate electronic device. Moreover, it may also be advantageous to devise a method of operating the interactive projection-mapped visualization system that provides the immersive mixed-reality theme park environment.

### SUMMARY

Summary and Abstract summarize some aspects of the present invention. Simplifications or omissions may have been made to avoid obscuring the purpose of the Summary or the Abstract. These simplifications or omissions are not intended to limit the scope of the present invention.

In a preferred embodiment of the invention, a method of operating a novel mixed-reality theme park system is disclosed. This method comprises the steps of: (1) capturing or retrieving multimedia data to be utilized in a projection-mapping environment; (2) identifying and separating mapped objects from background projection images in the multimedia data by utilizing a projection-mapped object and background image separation module executed in a visualization graphics processing module of the MR theme park system; (3) storing the mapped objects and the background projection images separately in a projection-mapping environment generation server, which is a component of the visualization graphics processing module in the MR theme park system; (4) projecting the mapped objects and the background projection images on a projection screen as the projection-mapping environment via a projector unit that integrates a user gesture command-tracking and user movement-tracking sensor, wherein the projector unit is incorporated into the MR theme park system; (5) with the user gesture command-tracking and user movement-tracking sensor integrated in the projector unit, tracking and recording gesture interactions between a user and each mapped object projected on the projection screen; (6) providing a visual synchronization of a user-selected mapped object transferring to or out of the projection-mapping environment and a user-specific mixed-reality (MR) environment based on a user's gesture command interpreted by the user gesture command-tracking and user movement-tracking sensor integrated into the projector unit, wherein the user-specific MR environment is executed by the user's personal electronic device independent from the projection-mapping environment; (7) providing an underlying data and metadata synchronization of the user-selected mapped object transferring to or out of the projection-mapping environment and the user-specific MR environment; and (8) enabling the user's mixed-reality (MR) headset device to visualize environmental transition graphics occurring between the projection-mapping environment on the projection screen and the user-specific MR environment outside of the projection screen, wherein the environmental transition graphics are a visual confirmation of an execution of the user's gesture command to transfer the user-selected mapped object.

### BRIEF DESCRIPTION OF DRAWINGS

FIG. 1 shows a mixed-reality (MR) theme park system generating projection-mapped objects that are configured to interact with a user's touch, in accordance with an embodiment of the invention.

FIG. 2 shows a mixed-reality theme park system generating a projection-mapped object transitioning to a three-dimensional (3D) hologram in a user's mixed-reality environment with the user's “pull” gesture, in accordance with an embodiment of the invention.

FIG. 3 shows a mixed-reality theme park system providing transfer-out or transfer-in of virtual objects between a projection-mapping environment and a user's separate mixed-reality environment, in accordance with an embodiment of the invention.

FIG. 4 shows a mixed-reality theme park system providing seamless interplay between a projection-mapping environment and a user's separate mixed-reality environment via real-time object synchronization, in accordance with an embodiment of the invention.

FIG. 5 shows a mixed-reality theme park system providing adoption or release of virtual animals or objects between a projection-mapping environment and a user's separate mixed-reality environment, in accordance with an embodiment of the invention.

FIG. 6 shows an example of onsite installation components for a mixed-reality theme park system, in accordance with an embodiment of the invention.

FIG. 7 shows a perspective view of a user's visualization fields in a mixed-reality theme park system, in accordance with an embodiment of the invention.

FIG. 8 shows an overall system block diagram for a mixed-reality theme park system, in accordance with an embodiment of the invention.

FIG. 9 shows internal components in the projection-mapping object and mixed-reality holographic object transfer accommodation module of the mixed-reality theme park system as illustrated in FIG. 8, in accordance with an embodiment of the invention.

FIG. 10 shows an operation flowchart for a mixed-reality theme park system, in accordance with an embodiment of the invention.

FIG. 11 shows an operation flowchart for projection-mapped object to mixed-reality holographic object adoption in a mixed-reality theme park system, in accordance with an embodiment of the invention.

FIG. 12 shows an operation flowchart for mixed-reality holographic object to projection-mapping environment object transfer in a mixed-reality theme park system, in accordance with an embodiment of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

The detailed description is presented largely in terms of description of shapes, configurations, and/or other symbolic representations that directly or indirectly resemble one or more electronic systems and methods for a novel mixed-reality theme park enabled by seamless real-time object synchronizations, transformations, and transfers between a projection-mapping environment and a user's separate mixed-reality environment. These process descriptions and representations are the means used by those experienced or skilled in the art to most effectively convey the substance of their work to others skilled in the art.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment. Furthermore, separate or alternative embodiments are not necessarily mutually exclusive of other embodiments. Moreover, the order of blocks in process flowcharts or diagrams representing one or more embodiments of the invention do not inherently indicate any particular order and do not imply any limitations in the invention.

One objective of an embodiment of the present invention is to provide a novel interactive projection-mapped visualization system that can project desired moving images of environments and objects on a large surface at a targeted location (e.g. a large vertical wall, a sidewall of a building, etc.), wherein the projected moving images of objects can be transferred out (i.e. “popped out”) of the projection-mapping environment to become three-dimensional (3D) holograms in a mixed-reality (MR) environment operated by a user's separate and personal electronic device (e.g. an MR headset, a smart phone, etc.).

Furthermore, another objective of an embodiment of the invention is to provide a novel interactive projection-mapped visualization system that accommodates seamless transfers of synthetic graphical objects between a projection-mapping environment controlled by a projection system and a mixed-reality environment operated by a user's separate and personal electronic device during the user's visualization of the projection-mapping environment on a large surface at a targeted location.

Another objective of an embodiment of the present invention is to provide a novel interactive projection-mapped visualization system that incorporates seamless bilateral user interactivity with a projected environment and objects displayed on a large surface at a targeted location by capturing, tracking, and reacting to defined user gestures or other user-activated commands in front of the projected environment and objects.

In addition, another objective of an embodiment of the present invention is to provide an immersive mixed-reality theme park environment generated from a novel interactive projection-mapped visualization system by projecting a user-selected thematic environment and objects on a large surface at a targeted location, and by accommodating seamless bilateral user interactivity and object transfers between a projection-mapping environment and a mixed-reality environment operated by the user's separate electronic device. Moreover, another objective of an embodiment of the present invention is to provide a method of operating the immersive mixed-reality theme park environment generated from the interactive projection-mapped visualization system.

For the purpose of describing the invention, a term referred to as “mixed reality,” or “MR,” as an acronym, is defined as an intermixture of computer-generated lifelike holographic objects and real physical objects that are synchronized and correlated to a particular physical space (e.g. a physical wall in a room, a sidewall of a building, etc.) for immersive user interactions during the user's actual or virtual visit to the particular physical space. Typically, unlike conventional augmented reality applications, the computer-generated lifelike holographic objects are ultra high-resolution (e.g. 4K/UHD) or high-resolution (e.g. HD quality or above) three-dimensional synthetic objects that are intermixed and/or juxtaposed to real physical objects, wherein a viewer immersed in the mixed-reality environment is often unable to distinguish the synthetic nature of the computer-generated lifelike holographic objects and the real physical objects provided by the mixed-reality environment. The viewer immersed in a mixed-reality environment may be locally present at a particular physical space (e.g. a physical wall of a structure functioning as a computer graphics-projected virtualized theme park), which is correlated and synchronized with the computer-generated lifelike holographic objects and the real physical objects in one or more mixed-reality artificial layers superimposed on the particular physical space. Alternatively, the viewer may also be remotely located in a different physical space (e.g. the viewer's own residence) but still correlated and synchronized with the particular physical space (e.g. the physical wall of the structure functioning as a computer graphics-projected virtualized theme park) to be immersed in a holographic and physical mixed-reality (HPMR) environment that provides the computer-generated lifelike holographic objects, wherein the HPMR environment is synthesized and visualized in real time to the viewer, and allows the viewer to interact with a projection-mapping environment that incorporates projected and/or holographic objects, which respond to the viewer's gesture commands in real time. Typically, the viewer is required to wear a mixed-reality recording headset or another wearable computing device to visualize and participate in the HPMR environment that represents a computerized virtual theme park and objects and elements of the theme park that are projected to a particular physical space.

Moreover, for the purpose of describing the invention, a term referred to as “projection-mapping environment” or “projection-mapped environment” is defined as a computer-generated visualization environment that utilizes spatial-mapping on virtual coordinates to transform a targeted location (e.g. a large wall in a room, a building sidewall, a large irregularly-shaped object, etc.) into an image and/or video projection surface. In a preferred embodiment of the invention, the projection-mapping environment is controlled by a specialized projection-mapping software that can spatially map a targeted location on virtual coordinates, which are defined in a computer graphics server executing the specialized projection-mapping software. The computer graphics server is then able to produce images and/or videos for projection purposes, with bespoke visualization effects optimized for the targeted location as its projection surface.

Examples of projection-mapped environments include, but are not limited to, artistic and/or architectural contents in motion, or natural landscapes in motion (e.g. a mountainous habitat, a desert ecosystem, an oceanic underwater environment, an Artic iceberg, an outer space, etc.). In the preferred embodiment of the invention, the spatial-mapping and the projection of various themes and environments on the targeted location are intended to mimic the sense of real-life physical visualization of the projected themes and environments for viewers. The specialized projection-mapping software is capable of controlling the projector to provide overlays of any desired images of objects onto the surface of the targeted location.

In addition, for the purpose of describing the invention, a term referred to as “projection-mapped object,” or “mapped object” is defined as a still or moving digitized image of an object with computer-assigned virtual coordinates mapped in a computer graphics server for custom surface-optimized image projection on a targeted location as a projection surface. Typically, a projection-mapped object (e.g. a fish, a whale, another sea animal, etc.) is superimposed onto a still or moving background image representing a projection-mapped environment (e.g. an ocean, an underwater ecosystem, etc.), and is configured to be animated, interacted with, and controlled freely and independently from the projection-mapped environment via a user-invoked command. Examples of projection-mapped objects include, but are not limited to, computer graphics-transformed and digitized manifestations of animals, items, or visual features that can be visually superimposed onto or blended into a projection-mapped environment.

Furthermore, for the purpose of describing the invention, a term referred to as “adoption” is defined as “transferring out” a projection-mapped object visualized in a projection-mapping environment to a user's separate mixed-reality environment, which is operated by the user's separate electronic device during the user's visualization of the projection-mapping environment on a large surface at a targeted location. For example, the user may invoke adoption of an orca calf (i.e. a projection-mapped object) displayed in a projection-mapping environment (i.e. representing an underwater ocean ecosystem) by using a “pull” gesture command on the orca calf shown on the projection screen. In this example, the transfer-out or “adoption” of this particular projection mapped object (i.e. the orca calf) from the projection-mapping environment to the user's separate mixed-reality environment is completed when the orca calf is “pulled out” from the projection screen, and then newly appears in the user's smart phone display screen executing an animal adoption interface.

Moreover, for the purpose of describing the invention, a term referred to as “release” is defined as “transferring in” a user's mixed-reality (MR) holographic object stored in the user's separate electronic device to a projection-mapping environment operated by a mixed-reality (MR) theme park system. In a preferred embodiment of the invention, the transfer-in, or “release” of the user's MR holographic object is initiated if the user selects and invokes the release of the holographic object to the projection-mapping environment. For example, by utilizing a gesture command over the projection screen or a mobile app user interface, the user may invoke the release of an orca calf from the user's separate electronic device to the simulated wildlife environment (i.e. the projection-mapping environment) of the underwater ocean ecosystem displayed on a projection screen by the MR theme park system. In this example, the orca calf may have been previously adopted by the user from the MR theme park system, or may have been a user's native holographic pet. From a visualization perspective, the release of the orca calf can be considered to be completed when the orca calf appears in the simulated wildlife environment (i.e. the projection-mapping environment) of the underwater ocean ecosystem on the projection screen controlled by the MR theme park system, while the user's separate electronic device relinquishes a direct control of the released orca calf.

In addition, for the purpose of describing the invention, a term referred to as a “mixed-reality artificial layer” is defined as a computer-generated graphics layer in which mixed-reality holographic objects (MROs) (e.g. sea animals and plants in a computer-simulated oceanic theme park environment, desert animals, cacti, and red rocks in a computer-simulated Sonoran Desert theme park environment, etc.) are created and positioned by a mixed-reality theme park system onto virtual coordinates, which correlate to a particular projection space with a viewer's immersed presence in a projection-mapping environment generated by the mixed-reality theme park system.

Moreover, for the purpose of describing the invention, a term referred to as “hologram” is defined as a three-dimensional holographic object configured to be displayed from a head-mounted display (HMD) device, a mobile device executing a mixed-reality visual mobile application, or another electronic device with a visual display unit. Typically, a hologram is capable of being animated as a three-dimensional element over a defined period of time.

In addition, for the purpose of describing the invention, a term referred to as “three-dimensional model,” or “3D model,” is defined as one or more computer-generated three-dimensional images, videos, or holograms. In a preferred embodiment of the invention, a computerized 3D model is created as a hologram after multi-angle video data are extracted, transformed, and reconstructed by three-dimensional graphics processing algorithms executed in a computer system or in a cloud computing resource comprising a plurality of networked and parallel-processing computer systems. The computer-generated 3D model can then be utilized as a mixed-reality object (MRO) or a humanized mixed-reality hologram (MRH) in a mixed-reality artificial layer superimposed on a particular physical space correlated by virtual coordinates from a mixed-reality theme park system.

Moreover, for the purpose of describing the invention, a term referred to as “cloud” is defined as a scalable data network-connected and/or parallel-processing environment for complex graphics computations, transformations, and processing. The data network-connected and/or parallel-processing environment can be provided using a physical connection, a wireless connection, or both. For example, a cloud computing resource comprising a first cloud computing server, a second cloud computing server, and/or any additional number of cloud computing servers can each extract and transform a portion of multi-angle video data simultaneously as part of a scalable parallel processing algorithm, which performs temporal, spatial, and photometrical calibrations, and executes depth map computation, voxel grid reconstruction, and deformed mesh generation. A scalable number of cloud computing servers enables a real-time or near real-time transformation and reconstruction of 3D models after consumer video recording devices transmit multi-angle video data to the cloud computing resource.

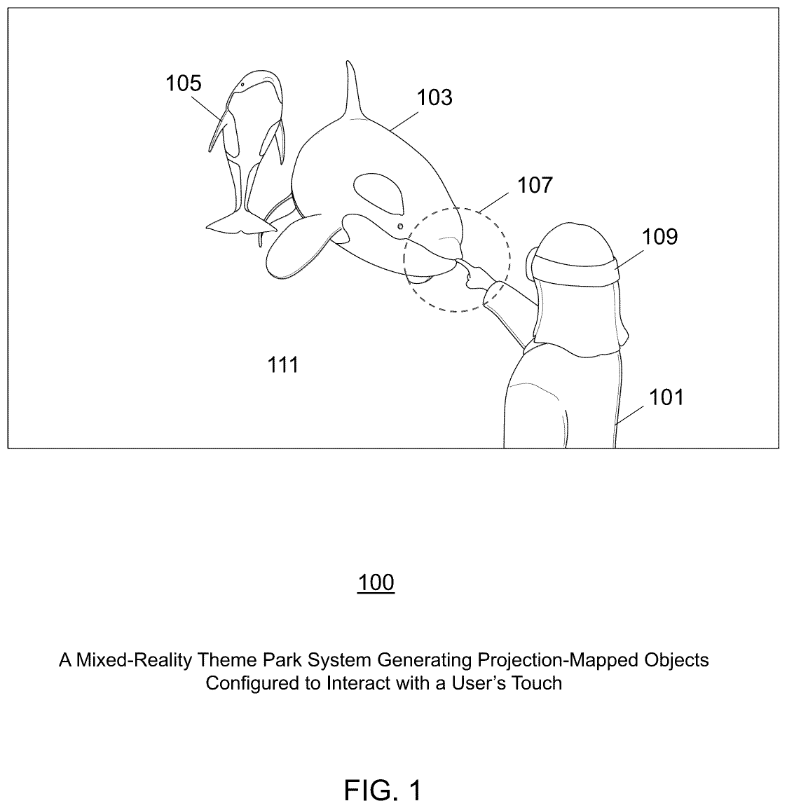

FIG. 1 shows a projection snapshot (100) from a mixed-reality (MR) theme park system generating projection-mapped objects (103, 105) that are configured to interact with a user's touch (107), in accordance with an embodiment of the invention. In the projection snapshot (100) as shown in FIG. 1, a first whale (103) and a second whale (105) are projection-mapped objects that are swimming in an simulated underwater ocean environment (111). In a preferred embodiment of the invention, these projection-mapped objects (103, 105) are generated as interactive computerized objects from the MR theme park system and projected onto the simulated underwater ocean environment (111) on a projection screen using a projector unit operatively connected to the MR theme park system.

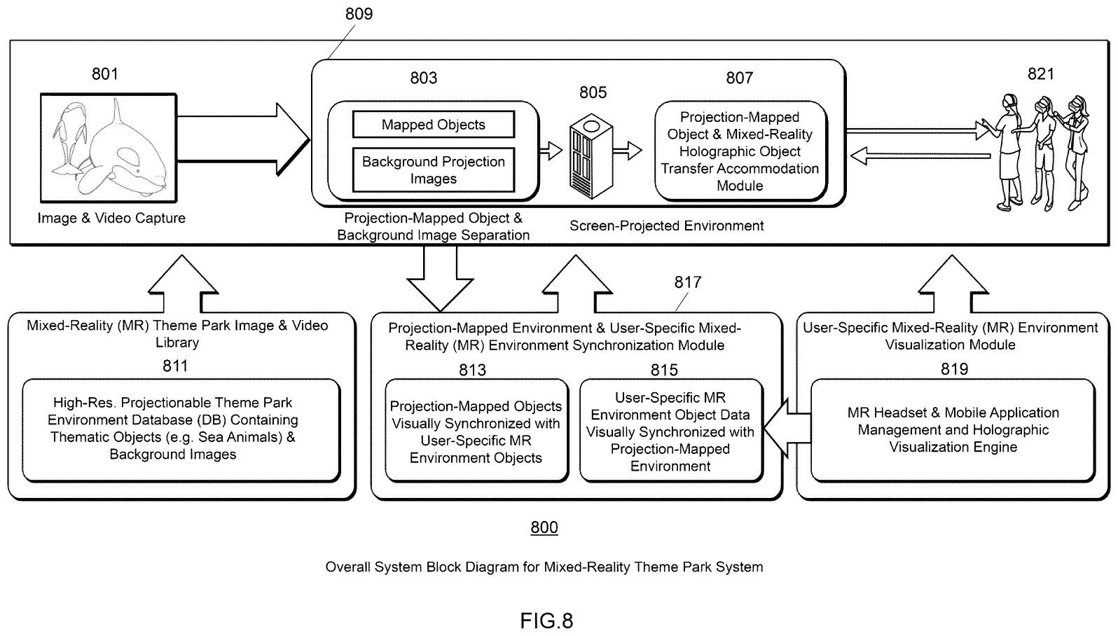

As illustrated in FIG. 1, in the preferred embodiment of the invention, the user (101) wears a mixed-reality (MR) headset unit (109), which is configured to visualize the simulated underwater ocean environment (111) projected from the projector unit onto the projection screen as well as any projection-mapped objects (e.g. 103, 105) that may be partially or fully transformed from two-dimensional (2D) objects on the projection screen to three-dimensional (3D) holograms, based on the user's touch or gesture command-based interactions with each projection-mapped object. In the preferred embodiment of the invention, the transformation from a 2D object on the projection screen to a 3D hologram is graphically enabled and executed by an object transfer and synchronization between the simulated underwater ocean environment (111) generated and managed by the MR theme park system and a user-specific and separate MR environment visualization module (e.g. 819 in FIG. 8) executed on the user's MR headset unit (109) or on another portable electronic device (e.g. a smart phone, a tablet device, a notebook computer) that the user brought to the computerized theme park projection location.

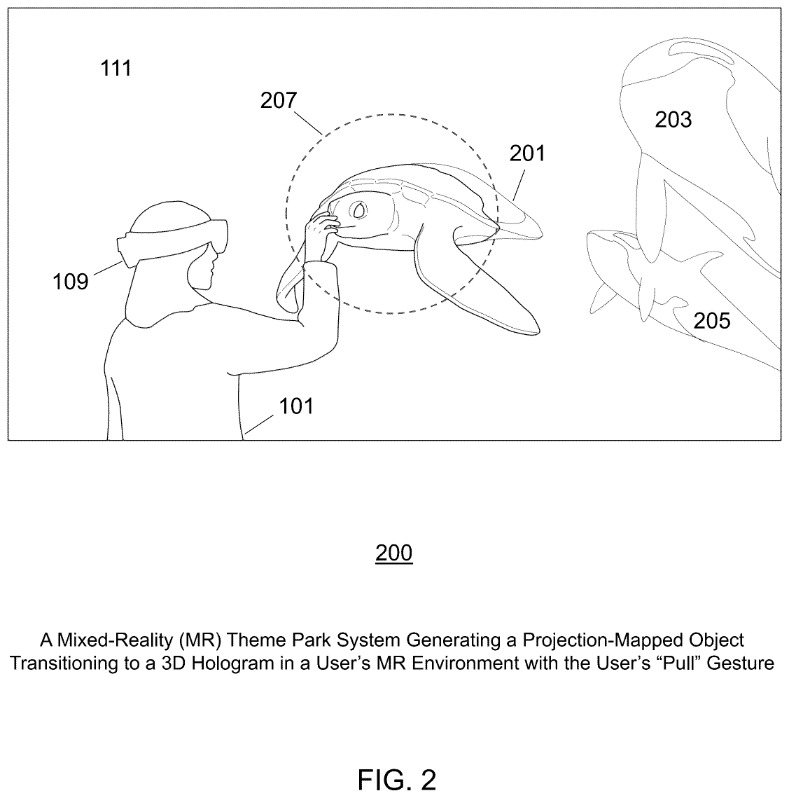

In the projection snapshot (100) of FIG. 1, the user (101) is touching the lip of the first whale (103) swimming in the simulated underwater ocean environment (111), which in turn brightens the area near the user's touch (107) when visualized by the user's MR headset unit (109), as illustrated in FIG. 1 with a dotted circle. At her discretion, the user (101) may choose to engage in an additional touch movement or a gesture command to interact with the first whale (103) or the second whale (105) further, which will be reflected on the projection screen or on the space in front of the projection screen dynamically in real time. Some examples of such dynamic interactions between users and projection-mapped objects are illustrated in FIGS. 2-5 and elaborated in detail below.

FIG. 2 shows another projection snapshot (200) of the mixed-reality theme park system generating a projection-mapped object (i.e. 201) transitioning to a three-dimensional (3D) hologram (i.e. 207) in a user's mixed-reality environment with the user's “pull” gesture, in accordance with an embodiment of the invention. In the projection snapshot (200) as shown in FIG. 2, a sea turtle (201), a first whale (203), and a second whale (205) are projection-mapped objects that are swimming in the simulated underwater ocean environment (111), which is generated, projected, and managed by the MR theme park system. In a preferred embodiment of the invention, these projection-mapped objects (201, 203, 205) are generated as interactive computerized objects from the MR theme park system and projected onto the simulated underwater ocean environment (111) on a projection screen using a projector unit operatively connected to the MR theme park system.

As illustrated in FIG. 2, in the preferred embodiment of the invention, the user (101) wears the mixed-reality (MR) headset unit (109), which is configured to visualize the simulated underwater ocean environment (111) projected from the projector unit onto the projection screen as well as any projection-mapped objects (e.g. 201, 203, 205) that may be partially or fully transformed from two-dimensional (2D) objects on the projection screen to three-dimensional (3D) holograms, based on the user's touch or gesture command-based interactions with each projection-mapped object. In the particular example presented in the projection snapshot (200) of FIG. 2, the user (101) makes a “pull” gesture command at the lip of the sea turtle (201) as shown in a dotted circle (207), which in turn enables the sea turtle (201) to be “pulled out” of the projection screen and gradually transformed into a three-dimensional (3D) hologram coming out of the screen, from the perspective of the user (101) visualizing the space around the simulated underwater ocean environment (111) with the MR headset unit (109). In this example, the first whale (203) and the second whale (205) may appear to be contained on a two-dimensional plane on the projection screen, unless the user (101) decides to “pull” at least one of the two whales out of the projection screen with a “pull” gesture command, which initiates a graphical and visual transformation of the selected whale into a partial or full 3D hologram pulled out of the projection screen.

In the preferred embodiment of the invention, the transformation from a 2D object on the projection screen to a 3D hologram is graphically enabled and executed by an object transfer and synchronization between the simulated underwater ocean environment (111) generated and managed by the MR theme park system and a user-specific and separate MR environment visualization module (e.g. 819 in FIG. 8) executed on the user's MR headset unit (109) or on another portable electronic device (e.g. a smart phone, a tablet device, a notebook computer) that the user brought to the computerized theme park projection location. In the projection snapshot (200) of FIG. 2, the user (101) is touching and pulling the lip of the sea turtle (201) swimming in the simulated underwater ocean environment (111) with the “pull” gesture command, which in turn brightens the area near the user's touch and transforms a “pulled” portion of the sea turtle's (201) body into a 3D hologram as the sea turtle (201) is pulled out of the projection screen, when visualized by the user's MR headset unit (109), as illustrated in FIG. 2 with the dotted circle (207). At her discretion, the user (101) may choose to engage in another gesture command to interact with the sea turtle (201) or other animals (e.g. 203, 205), which will be reflected on the projection screen or on the space in front of the projection screen dynamically in real time.

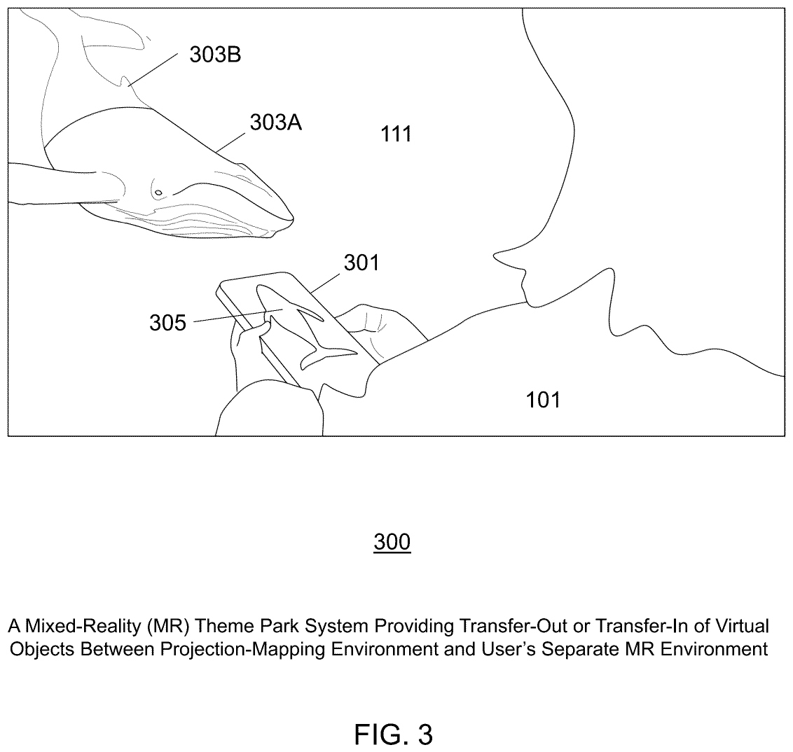

FIG. 3 shows another projection snapshot (300) of the mixed-reality (MR) theme park system, which in this instance provides transfer-out or transfer-in of a virtual object (i.e. 303A and 303B to 305 and vice versa) between a projection-mapping environment (i.e. 111) operated by the MR theme park system and a user's separate mixed-reality (MR) environment executed by the user's own device (i.e. 301), in accordance with an embodiment of the invention. In the projection snapshot (300) as shown in FIG. 3, the user (101) initiates a command on her mobile device (301) to transfer a projection-mapped object (i.e. a humpback whale (303A, 303B)) swimming in the projection-mapping environment (i.e. in the simulated underwater ocean environment (111)) to the user's separate MR environment operating in her mobile device (301).

As illustrated in the projection snapshot (300), as the humpback whale is transferred from the projection-mapping environment to the user's separate MR environment, a frontal portion (303A) of the humpback whale gradually transforms into a 3D hologram out of the projection screen while a back portion (303B) of the humpback whale still remains on the projection screen, when viewed by the MR headset unit worn by the user (101). Furthermore, a mobile application instance (305) of the humpback whale (303A, 303B) now appears inside the user's mobile device (301) operating the user's separate mixed-reality (MR) environment. In one example, the mobile application instance (305) of the humpback whale (303A, 303B) may be mutually exclusive with the humpback whale (303A, 303B) swimming in the simulated underwater ocean environment (111), which means that there is only one unique instance of the humpback whale, whether it is present in the projection-mapping environment (the simulated underwater ocean environment (111)) or in the user's separate mixed-reality (MR) environment inside the user's mobile device (301). In another example, the mobile application instance (305) of the humpback whale (303A, 303B) may exist in one or more duplicates across many systems, which means that there are potentially many instances of a chosen virtual object in a plurality of user MR environments in multiple user mobile devices.

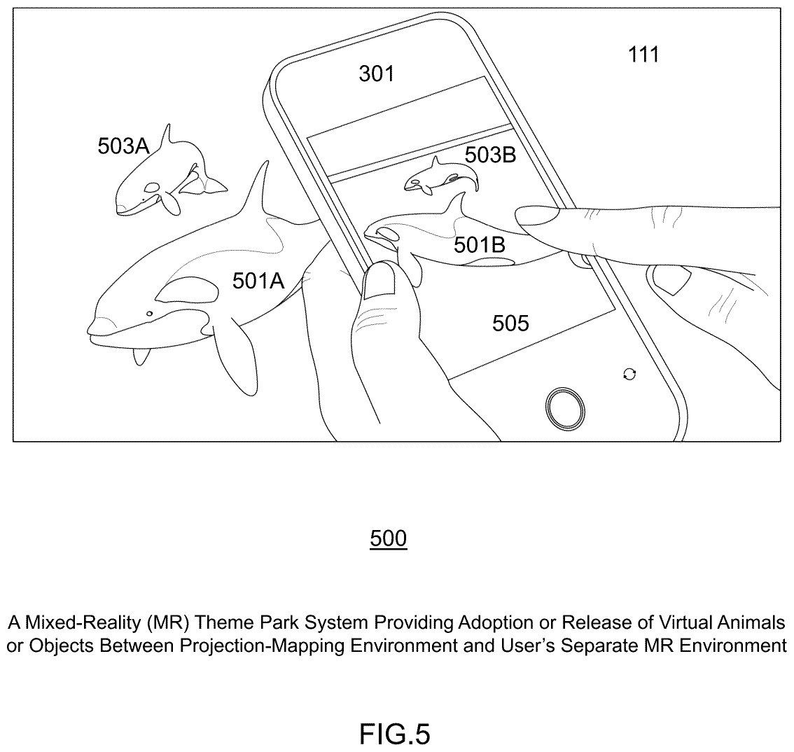

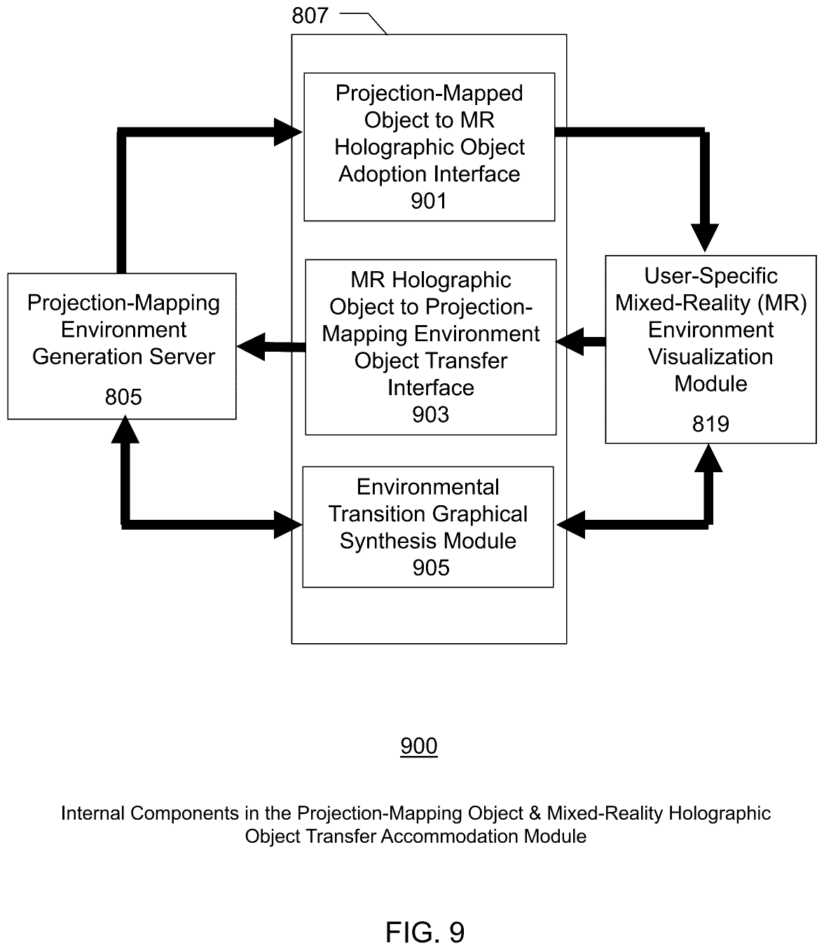

In a preferred embodiment of the invention, the user-initiated virtual object transfer process may be part of a virtual animal adoption or release process accommodated by the MR theme park system, which is further described in association with FIG. 5. In the preferred embodiment of the invention, the transformation from a 2D object on the projection screen to a 3D hologram is graphically enabled and executed by an object transfer and synchronization between the simulated underwater ocean environment (111) generated and managed by the MR theme park system and a user-specific and separate MR environment visualization module (e.g. 819 in FIG. 8) executed on the user's MR headset unit and/or the user's mobile device (301), which the user brought to the computerized theme park projection location. The seamless object transfer and synchronization between the projection-mapping environment (e.g. the simulated underwater ocean environment (111)) and the user's separate mixed-reality (MR) environment executed in the user's own device (i.e. 301) are enabled, or made possible, by utilizing a projection-mapped object and mixed-reality (MR) holographic object transfer accommodation module (e.g. 807 in FIG. 8) and a projection-mapped environment and user-specific MR environment synchronization module (e.g. 817 in FIG. 8), which are further described in conjunction with FIGS. 8-9.

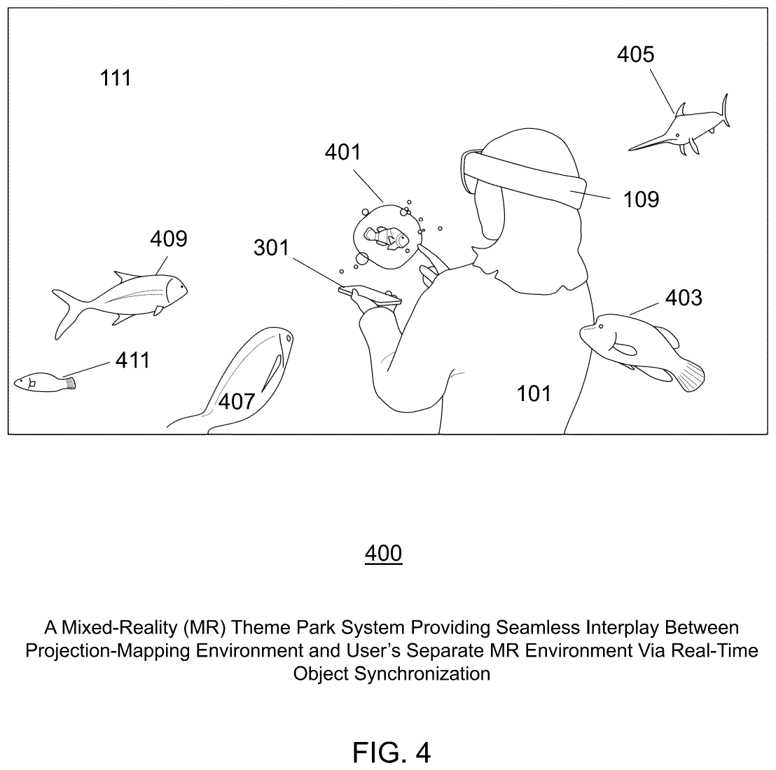

FIG. 4 shows another projection snapshot (400) of the mixed-reality theme park system, which in this instance provides a seamless interplay between a projection-mapping environment (i.e. 111) operated by the MR theme park system and a user's separate MR environment executed by the user's own device (i.e. 301) via real-time object synchronization, in accordance with an embodiment of the invention. In the projection snapshot (400) as shown in FIG. 4, the user (101) retrieves a personal virtual object (i.e. a pet fish (401)) from her mobile device (301) executing the user's separate MR environment, and then floats or inserts the pet fish (401) in the simulated underwater ocean environment (111) harboring various wildlife fish species (i.e. 403, 405, 407, 409, 411) on a projection screen, which is operated by the MR theme park system controlling its interactive projector unit.

As illustrated in the projection snapshot (400), the personal virtual object (i.e. the pet fish (401)) is transferred from the user's separate MR environment operating from the user's mobile device (301) to the projection-mapping environment (i.e. the simulated underwater ocean environment (111)) operated by the MR theme park system. The pet fish (401) in this example appears encapsulated in a bubble while interacting with various wildlife fish species (i.e. 403, 405, 407, 409, 411) on the projection screen, which visually differentiates the user's personal virtual object (i.e. the pet fish (401)) from the wildlife fish belonging to the simulated underwater ocean environment (111), when viewed through the user's MR headset unit (109).

FIG. 5 shows another projection snapshot (500) of the mixed-reality (MR) theme park system providing adoption or release of virtual animals or objects between a projection-mapping environment (i.e. 111) operated by the MR theme park system and a user's separate mixed-reality environment executed by the user's own device (i.e. 301), in accordance with an embodiment of the invention. In the projection snapshot (500) as shown in FIG. 5, the user's finger is pointing at a mobile application instance (505) of two dolphins (501B, 503B) contained in the user's separate MR environment in her mobile device (301). A projection-mapped instance of the two corresponding dolphins (501A, 503A) are also projected on a projection screen in the projection-mapping environment (i.e. in the simulated underwater ocean environment (111)), as illustrated in FIG. 5.

At her discretion, the user may decide to “adopt” one or two of the dolphins (501A, 503A) from the projection-mapping environment to the user's separate MR environment in her mobile device (301) by initiating a command on her mobile device (301) or a gesture command on the projection screen representing the simulated underwater ocean environment (111). In context of various embodiments of the invention, an “adoption” is defined as “transferring out” a projection-mapped object (e.g. 501A or 503A) visualized in a projection-mapping environment (e.g. 111) to a user's separate mixed-reality environment (e.g. 505), which is operated by the user's separate electronic device (e.g. 301) during the user's visualization of the projection-mapping environment on a large surface at a targeted location.

For example, the user may invoke adoption of a dolphin (e.g. 501A or 503A) displayed in a projection-mapping environment (e.g. 111) by using a “pull” gesture command on the dolphin (e.g. 501A or 503A) shown on the projection screen. In this example, the transfer-out or “adoption” of this particular projection mapped object from the projection-mapping environment to the user's separate mixed-reality environment is completed when the selected dolphin (e.g. 501A or 503A) is “pulled out” from the projection screen, and then newly appears in the user's smart phone display screen executing an animal adoption interface (e.g. 505).

Furthermore, also at her discretion, the user may decide to “release” one or two of the dolphins (501B, 503B) from the user's separate MR environment in her mobile device (301) to the projection-mapping environment representing the simulated underwater ocean environment (111) by initiating a command on her mobile device (301) or a gesture command on the projection screen representing the simulated underwater ocean environment (111). In context of various embodiments of the invention, a “release” is defined as “transferring in” a user's mixed-reality (MR) holographic object (e.g. 501B or 503B) stored in the user's separate electronic device (e.g. 301) to a projection-mapping environment (e.g. 111) operated by a mixed-reality (MR) theme park system. In a preferred embodiment of the invention, the transfer-in, or “release” of the user's MR holographic object is initiated if the user selects and invokes the release of the holographic object (e.g. 501B or 503B) to the projection-mapping environment. For example, by utilizing a gesture command over the projection screen or a mobile app user interface, the user may invoke the release of a dolphin (e.g. 501B or 503B) from the user's separate electronic device (e.g. 301) to the simulated wildlife environment (e.g. 111) of the underwater ocean ecosystem displayed on a projection screen by the MR theme park system.

In this example, the selected dolphin (e.g. 501B or 503B) for release may have been previously adopted by the user from the MR theme park system, or may have been a user's native holographic pet. From a visualization perspective, the release of the dolphin can be considered to be completed when the selected dolphin for the release appears in the simulated wildlife environment (e.g. 111) of the underwater ocean ecosystem on the projection screen controlled by the MR theme park system, while the user's separate electronic device (e.g. 301) relinquishes a direct control of the released dolphin.

Moreover, in one example, the mobile application instance (505) of the dolphins (501B, 503B) may be mutually exclusive with the projection-mapping instance of the dolphins (501A, 503A) swimming in the simulated underwater ocean environment (111), which means that there is only one unique instance of each dolphin, whether it is present in the projection-mapping environment (the simulated underwater ocean environment (111)) or in the user's separate mixed-reality (MR) environment inside the user's mobile device (301). In another example, the mobile application instance (505) of the dolphins (501B, 503B) may exist in one or more duplicates across many systems, which means that there are potentially many instances of a chosen virtual object in a plurality of user MR environments in multiple user mobile devices.

In a preferred embodiment of the invention, the transformation from a 2D object on the projection screen to a 3D hologram is graphically enabled and executed by an object transfer and synchronization between the simulated underwater ocean environment (111) generated and managed by the MR theme park system and a user-specific and separate MR environment visualization module (e.g. 819 in FIG. 8) executed on the user's MR headset unit and/or the user's mobile device (301), which the user brought to the computerized theme park projection location. The seamless object transfer and synchronization between the projection-mapping environment (e.g. the simulated underwater ocean environment (111)) and the user's separate mixed-reality (MR) environment executed in the user's own device (i.e. 301) are enabled, or made possible, by utilizing a projection-mapped object and mixed-reality (MR) holographic object transfer accommodation module (e.g. 807 in FIG. 8) and a projection-mapped environment and user-specific MR environment synchronization module (e.g. 817 in FIG. 8), which are further described in conjunction with FIGS. 8-9.

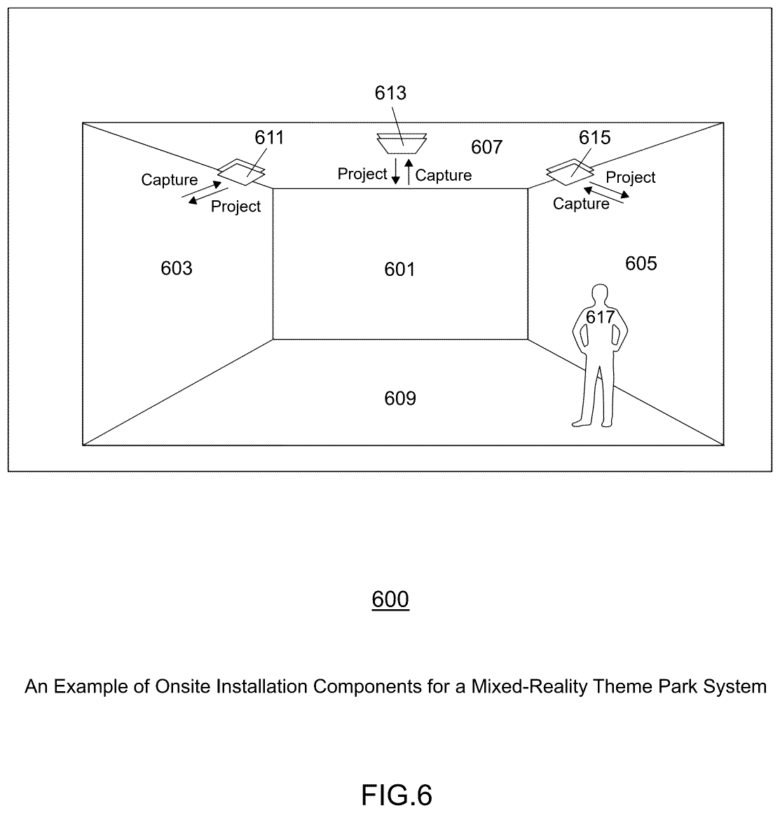

FIG. 6 shows an example (600) of onsite installation components for a mixed-reality (MR) theme park system, in accordance with an embodiment of the invention. The onsite installation components for the MR theme park system in this example (600) incorporate a first projector unit (613) that integrates a first camera unit, a first infrared sensor, a first movement sensor, a first radar, a first laser-based movement detector, another sensor, or any combination thereof to detect, capture, and track a user's gesture command or user movements in front of a first wall (601), which functions as a first projection screen for the MR theme park system. Likewise, the MR theme park system in this example (600) also incorporates a second projector unit (611) that integrates a second first camera unit, a second infrared sensor, a second movement sensor, a second radar, a second laser-based movement detector, another sensor, or any combination thereof to detect, capture, and track the user's gesture command or user movements in front of a second wall (603), which functions as a second projection screen for the MR theme park system. Similarly, the MR theme park system in this example (600) also incorporates a third projector unit (615) that integrates a third camera unit, a third infrared sensor, a third movement sensor, a third radar, a third laser-based movement detector, another sensor, or any combination thereof to detect, capture, and track the user's gesture command or user movements in front of a third wall (605), which functions as a third projection screen for the MR theme park system.

By utilizing three separate projector units (613, 611, 615), each of which designed to project vivid high-resolution images and/or videos onto a designated wall (i.e. 601, 603, 605), the MR theme park system is able to provide an immersive and visually-surrounding experience to a user (617) standing in a studio space (609), which is dedicated to create a projection-mapping environment as a computerized and simulated mixed-reality theme park. Because the three separate projector units (613, 611, 615) as onsite installation components in this example (600) are also configured to detect, capture, and tracking the user's gesture command or user movements with its integrated cameras and sensors, the MR theme park system is able to provide a real-time interactive environment between mapped objects on multiple projection screens and the user (617).

For example, the user (617), in one instance, is empowered to transform a selected mapped object into a three-dimensional (3D) hologram pulled out of a projection screen through a gesture command. In another instance, the user (617) is empowered to transfer, or “adopt,” the selected mapped object to the user's personal mixed-reality environment executed by the user's own electronic device, such as a smart phone, a tablet computer, or an integrated visualization headset unit. In some embodiments of the invention, the onsite installation components for the MR theme park system may also incorporate additional projector units and user command or movement detection cameras and sensors to cover other surfaces of the studio space (609), such as a ceiling (607) or a floor on the studio space (609), to enhance the user's immersive and visually-surrounding experience further when visualizing the projection-mapping environment.

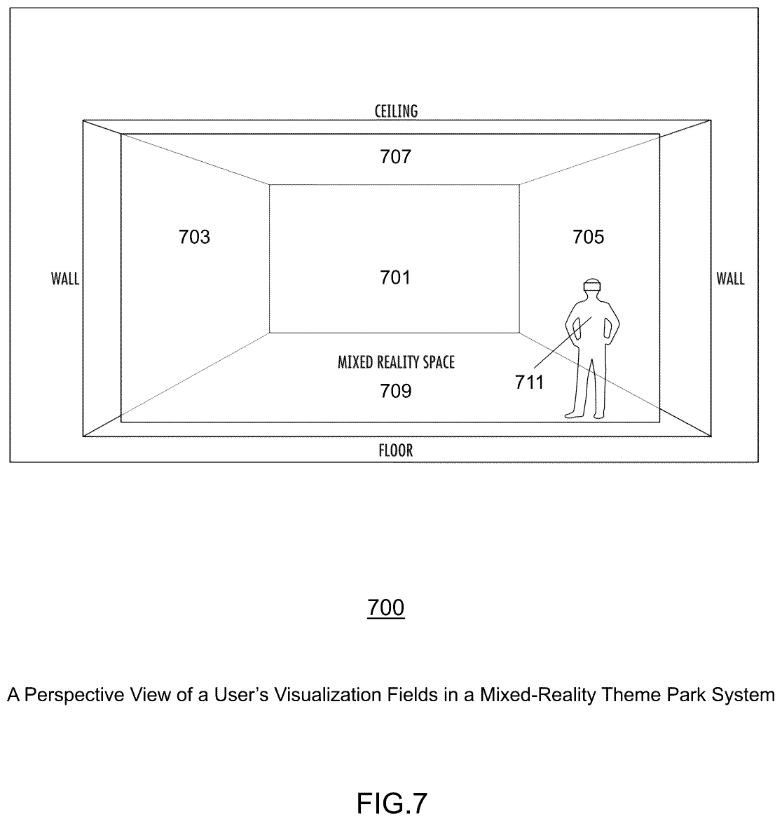

FIG. 7 shows a perspective view (700) of a user's visualization fields in a mixed-reality theme park system, in accordance with an embodiment of the invention. In this example, a user (711) wears a mixed-reality (MR) headset unit to visualize a computerized theme park environment in a MR theme park studio space, which comprises three vertical sidewalls (701, 703, 705), a floor (709), and a ceiling (707). In a preferred embodiment of the invention, three projector units operatively connected to an MR theme park system each project a thematic panoramic video comprising mapped objects and background projection images on the three vertical sidewalls (701, 703, 705). The mapped objects embedded in the thematic panoramic video are dynamically transferable to the user's (711) personal MR environment operated by the user's (711) personal electronic device, and also transformable from a two-dimensional (2D) image on the projection screen to a three-dimensional (3D) hologram that “popped out” of the flat projection screen upon receiving a user-invoked gesture command.

The MR theme park studio space also integrates user gesture command and user movement tracking tools (e.g. cameras, infrared sensors, movement sensors, radars, laser-based movement detectors, etc.) and software (e.g. human movement detection and hand-tracking software) that are either integrated into or connected to each projector unit to capture, decipher, and react to the user's (711) gesture commands and movements to accommodate a real-time interactivity between the mapped objects on the projection screens and the user (711). In some embodiments of the invention, the MR theme park system may deploy more or less than three projector units to create an immersive projection-mapped theme park environment, and may also utilize the ceiling (707) and/or the floor (709) as additional projection screen surfaces as part of creating the projection-mapped theme park environment. Although the user (711) is typically expected to wear an MR headset to experience the full capabilities of the MR theme park system involving dynamic user interactions with mapped objects on projection screens and real-time transformations from the mapped objects to holograms and vice versa, in some embodiments of the invention, these user interactivities with the MR theme park system may be implemented entirely as an auto-stereoscopy that does not require a physical use of MR headsets or other computer-aided visualization glasses.

FIG. 8 shows an overall system block diagram (800) for a mixed-reality (MR) theme park system, in accordance with an embodiment of the invention. In this instance, the MR theme park system comprises several components, modules, and stages to operate coherently as an electronic system that provides a projection-mapped theme park environment with real-time object transfers, transformations, and user interactivity. As illustrated in the overall system block diagram (800), high-resolution image(s) and video(s) (801) may be recorded from a natural environment or synthetically created from computer graphics processing units (GPUs) and graphics-creations software.

In context of a preferred embodiment of the present invention, these high-resolution image(s) and video(s) (801), which may be recorded or synthesized in a high-definition (HD) (1024×768 pixels) or ultra-high definition (UHD) format (3840×2160 pixels or above), are designed to represent one or more thematic and panoramic environments that can be utilized as user-selectable or operator-selectable themes in the MR theme park system. For example, a first selectable set of high-resolution image(s) and video(s) (801) may represent an underwater ocean environment containing various sea animals, plants, and dynamic movements and scenery of the underwater ocean. In addition, a second selectable set of high-resolution image(s) and video(s) (801) may represent an outer space environment encompassing numerous planets, stars, galaxies, black holes, human-made spaceships, and/or astronauts. Furthermore, a third selectable set of high-resolution image(s) and video(s) (801) may represent a Sonoran desert environment containing various desert plants, animals, red rocks, desert scenery, rural highways, and desert skylines. In the preferred embodiment of the invention, an MR theme park system operator or a user is empowered to choose a particular theme out of multiple thematic choices to generate an immersive projection-mapped theme park environment on multiple projection surfaces in a dedicated theme park studio space.

As illustrated in the overall system block diagram (800) in FIG. 8, the high-resolution image(s) and video(s) (801) undergo several steps of specialized multimedia processing in a visualization graphics processing module (809) to make them suitable for dynamic and user-interactive projection. In particular, each stream of captured or synthesized videos is separated into two categories (i.e. mapped objects and background projection images) through a projection-mapped object and background image separation module (803). In the preferred embodiment of the invention, a mapped object is typically an animal, a plant, or an inanimate object embedded in a scenery representing a thematic environment. For example, a dolphin, a clam, a starfish, a coral reef, a sea turtle, a sea plant, and an underwater rock may be part of a recorded or computer graphics-synthesized high-resolution video (801) representing an underwater oceanic environment. In this instance, the projection-mapped object and background image separation module (803) incorporated in the visualization graphics processing module (809) of the MR theme park system can separate such animals, plants, and/or inanimate objects and transform them into distinct projection-mapped objects, each of which is now an independent and transferrable object defined by unique underlying symbolic representations and software codes.

The remaining part of the recorded or computer graphics-synthesized high-resolution video (801) can then be classified and separated as the background projection images by the projection-mapped object and background image separation module (803). In context of the example above, the separated background projection images may be the background underwater oceanic scenery showing an underwater current movement, air bubbles, underwater lighting conditions, wave movements near the surface of the ocean, and other background oceanic environmental features suitable for a computerized mixed-reality theme park environment representing the underwater ocean.

After the projection-mapped object and background image separation module (803) completes separation and classification of the mapped objects and the background projection images, the processed graphical datasets can be categorized and stored in a graphical processing computer server defined herein as a “projection-mapping environment generation server” (805), which utilizes a database (DB) (i.e. 811) to store and retrieve each categorized graphical dataset (i.e. a mapped object or a background projection image) upon a system user or operator request, and incorporates one or more graphical processing units (GPUS) to project and display the categorized graphical datasets on one or more projection screens to formulate a screen-projected projection-mapping environment for the mixed-reality (MR) theme park.

In context of the embodiment of the invention as shown in FIG. 8, a MR theme park image and video library (811) incorporates a high-resolution projectionable theme park environment database (DB) containing thematic objects and background images, wherein the database (DB) is operatively connected to the projection-mapping environment generation server (805) in the visualization graphics processing module (809). A system user or a system operator is able to select a desired theme from the MR theme park image and video library (811) to invoke the MR theme park system to synthesize a projection-mapped environment on multiple projection screens to formulate a desired theme park environment for the user (821). In the preferred embodiment of the invention, the projection-mapping environment is controlled by a specialized projection-mapping software executed in the projection-mapping environment generation server (805) that can spatially map a targeted location on virtual coordinates. The projection-mapping environment generation server (805) is then able to produce images and/or videos for projection purposes, with bespoke visualization effects optimized for each targeted location (e.g. 701, 703, 705 in FIG. 7) as its projection surface.

Furthermore, as shown in FIG. 8, the visualization graphics processing module (809) also integrates a projection-mapped object and mixed-reality (MR) holographic object transfer accommodation module (807), which is operatively connected to the projection-mapping environment generation server (805). The projection-mapped object and MR holographic object transfer accommodation module (807) is configured to coordinate and control computerized object transfers between the projection-mapping environment and a user-specific mixed-reality (MR) environment executed in a user's personal electronic device, such as the user's personal MR headset device or the user's smart phone. In context of the embodiment of the invention as illustrated in FIG. 8, the user's MR headset device executes a user-specific MR environment visualization module (819) incorporating an MR headset and mobile application management and holographic visualization engine. The user-specific MR environment visualization module (819) is designed to operate and manage the user's personal and private mixed-reality (MR) environment in the user's MR headset device and/or the user's smart phone, in which various virtual, computerized, and holographic items can be synthesized and controlled by the user.

In context of the embodiment of the invention as shown in FIG. 8, although the user's personal and private MR environment is a distinct and separate visualization environment from the screen-projected projection-mapping environment provided by the MR theme park system on multiple projection screens, the MR theme park system is designed to provide a seamless object transfer between the two environments by performing graphical data synchronizations in a projection-mapped environment and user-specific MR environment synchronization module (817). As illustrated in the overall system block diagram (800) in FIG. 8, this novel and unique synchronization module (817) comprises projection-mapped objects that are visually synchronized with user-specific environment objects (813) and user-specific MR environment object data that are visually synchronized with projection-mapped environment (815).

In the preferred embodiment of the invention, the projection-mapped environment and user-specific MR environment synchronization module (817) is capable of providing graphical data synchronizations in real-time or near real-time via data sharing between the projection-mapping environment and the user's personal and private MR environment at a refresh rate of a few milliseconds or microseconds. This means that in case of the preferred embodiment of the invention, visualizable object data between the two environments are synchronized at a data refresh rate of a few milliseconds or less, which in turn creates a smooth and seamless object transfer (e.g. adoption, release, “pop-out,” etc.) visualization experience for the user (821) viewing the projection screens, who is also simultaneously immersed in the user's personal and private MR environment through an MR headset.

Typically, the user's personal and private MR environment is provided by the MR headset and mobile application management and holographic visualization engine in the user-specific MR environment visualization module (819), which is executed by a central processing unit (CPU), a graphical processing unit (GPU), and a memory unit contained in the user's MR headset and/or the user's smart phone device. In the preferred embodiment of the invention, the user (821) is only able to visualize the screen-projected projection-mapping environment provided by the MR theme park system and the user's own MR environment provided by the user's personal electronic device simultaneously during her physical attendance at the MR theme park studio, and does not retain direct visualization of the screen-projected projection-mapping environment provided by the MR theme park system, if she steps out from the MR theme park studio. In contrast, the user (821) will retain her personal and private mixed-reality (MR) environment visualization through the MR headset and/or the smart phone device that continue to execute the user-specific MR environment visualization module (819), even if she is no longer physically present at the MR theme park studio.

FIG. 9 shows an example (900) of internal components in the projection-mapping object and mixed-reality (MR) holographic object transfer accommodation module (807) of the mixed-reality theme park system as illustrated in FIG. 8, in accordance with an embodiment of the invention. In this example (900), the projection-mapping object and MR holographic object transfer accommodation module (807) comprises a projection-mapped object to mixed-reality (MR) holographic object adoption interface (901), a mixed-reality (MR) holographic object to projection-mapping environment object transfer interface (903), and an environmental transition graphical synthesis module (905).

In the preferred embodiment of the invention, the projection-mapped object to MR holographic object adoption interface (901) is operatively connected to the projection-mapping environment generation server (805) and the user-specific MR environment visualization module (819), which were previously illustrated and described in association with FIG. 8. The projection-mapped object to MR holographic object adoption interface (901) in the projection-mapping object and MR holographic object transfer accommodation module (807) is configured to transfer, facilitate an adoption, or accommodate a transition of a projected object in the projection-mapping environment (i.e. operated by the projection-mapping environment generation server (805)) to the user's personal and private MR environment (i.e. operated by the user-specific MR environment visualization module (819) in the user's personal electronic device).

For example, if the user utilizes a gesture command to initiate a transfer-out or “pop out” of the projected object from the projection screen, the projection-mapped object to MR holographic object adoption interface (901) coordinates the projection-mapping environment generation server (805), the user-specific MR environment visualization module (819), and the environmental transition graphical synthesis module (905) to provide a seamless visual transformation of the 2D projection-mapped object on the projection screen to a 3D hologram visualized in the domain of the user's personal and private MR environment, when viewed, for example, through a mixed-reality (MR) headset. Furthermore, any metadata associated with the transferred-out object is also seamlessly shared and/or transferred from the projection-mapping environment generation server (805) to the user-specific MR environment visualization module (819).

Moreover, the MR holographic object to projection-mapping environment object transfer interface (903) is also operatively connected to the projection-mapping environment generation server (805) and the user-specific MR environment visualization module (819). The MR holographic object to projection-mapping environment object transfer interface (903) in the projection-mapping object and MR holographic object transfer accommodation module (807) is configured to transfer, facilitate a release, or accommodate a transition of the user's personal holographic object or a previously-adopted object currently contained in the user's personal and private MR environment (i.e. operated by the user-specific MR environment visualization module (819) in the user's personal electronic device) to the projection-mapping environment (i.e. operated by the projection-mapping environment generation server (805)).

For example, if the user invokes a command on her personal electronic device to initiate a transfer or a “release” of the previously-adopted object (e.g. a matured and previously-rescued cub) to the projection-mapping environment representing a simulated natural habitat, the MR holographic object to projection-mapping environment object transfer interface (903) coordinates the user-specific MR environment visualization module (819), the projection-mapping environment generation server (805), and the environmental transition graphical synthesis module (905) to provide a seamless visual transformation of the previously-adopted holographic object in the domain of the user's personal and private MR environment to a 2D projection-mapped object on the projection screen managed by the projection-mapping environment. In the preferred embodiment of the invention, the user may still utilize the MR headset to visualize the now-released and previously-adopted object on the projection screen, but can also visualize it directly with naked eyes, as the released object is now merely a projected object on the projection screen. Furthermore, any metadata associated with the released object from the user's personal and private MR environment is also seamlessly shared and/or transferred from the user-specific MR environment visualization module (819) to the projection-mapping environment generation server (805).

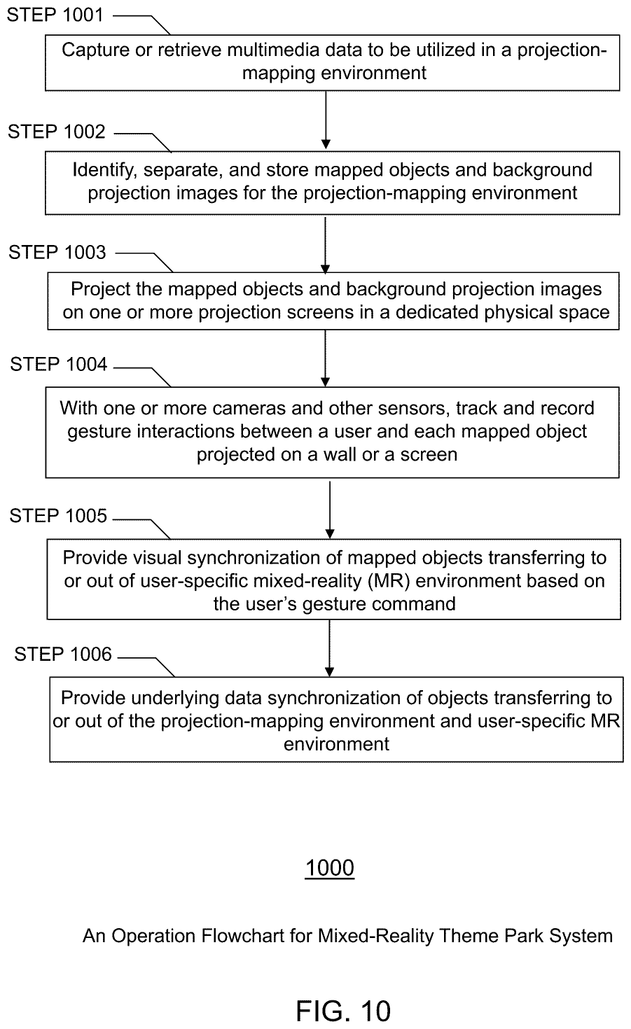

FIG. 10 shows an operation flowchart (1000) for a mixed-reality (MR) theme park system based on the overall system block diagram (i.e. 800 in FIG. 8) and some of its internal components (i.e. 900 in FIG. 9), in accordance with an embodiment of the invention. As illustrated in this operation flowchart (1000), the MR theme park system is configured to capture or retrieve multimedia data to be utilized in a projection-mapping environment, as shown in STEP 1001, the process of which is also previously described in association with elements 801, 809, and 811 in FIG. 8. Then, the projection-mapped object and background image separation module (i.e. 803 in FIG. 8) in the visualization graphics processing module (i.e. 809 in FIG. 8) of the MR theme park system is able to identify, separate, and store mapped objects and background projection images for the projection-mapping environment, as shown in STEP 1002. In the preferred embodiment of the invention, any mapped objects and background projection images that underwent processing in the projection-mapped object and background image separation module (i.e. 803 in FIG. 8) may be stored in a mixed-reality (MR) theme park image and video library (i.e. 811 in FIG. 8) and/or in a projection-mapping environment generation server (i.e. 805 in FIG. 8).

Then, as shown in STEP 1003, the MR theme park system is able to project the mapped objects and the background projection images on one or more projection walls or screens in a dedicated physical space (i.e. an MR theme park studio) based on an operator or user selection of a desired theme for creating a computerized mixed-reality (MR) theme park. As previously described in association with FIGS. 6˜8, the projection of the mapped objects and the background projection images on multiple walls is accomplished by one or more projector units (i.e. 611, 613, 615 in FIG. 6) that are each controlled by the visualization graphics processing module (i.e. 809 in FIG. 8) in the MR theme park system. Furthermore, as shown in STEP 1004, the each projector unit connected to the MR theme park system integrates user gesture and movement-tracking cameras and sensors, and tracks and records gesture interactions between a user and each mapped object projected on a wall, which was also previously described in association with FIG. 6.

Then, by utilizing the projection-mapped environment and user-specific MR environment synchronization module (i.e. 817 in FIG. 8), the MR theme park system is able to provide a visual synchronization of mapped objects transferring to or transferring out of user-specific MR environment based on the user's gesture command, as shown in STEP 1005. Furthermore, as the visual synchronizations of objects across two separate computer graphics-simulated environments (i.e. the projection-mapping environment and the user-specific MR environment) are achieved from the user's visual perspective through an MR headset or another display interface, the MR theme park system is also configured to provide an underlying data and metadata synchronization of objects transferring to or transferring out of the projection-mapping environment and used-specific MR environment, as shown in STEP 1006. Examples of object underlying data and metadata include, but are not limited to, object names, object creation or edit dates, object ownership information, object edit authorization information, object format, resolution, and other graphical attributes information.

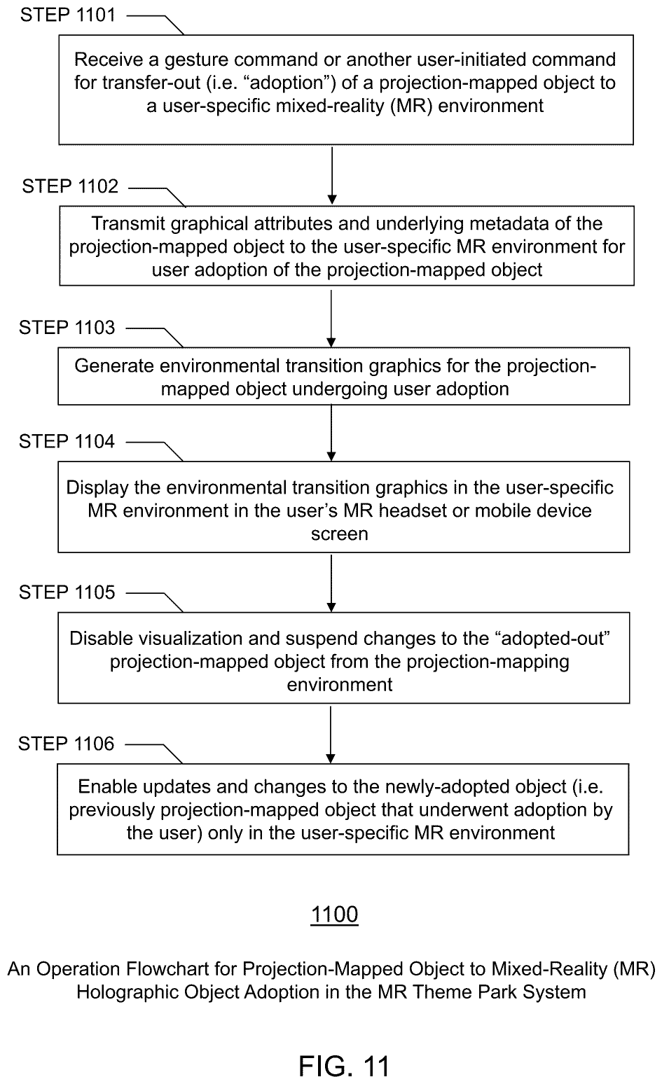

FIG. 11 shows an operation flowchart (1100) for a projection-mapped object to mixed-reality holographic object adoption process in a mixed-reality (MR) theme park system, in accordance with an embodiment of the invention. To initiate a transfer-out or an “adoption,” the MR theme park system receives a gesture command or another user-initiate command for the adoption of a projection-mapped object to a user-specific MR environment, as shown in STEP 1101. In context of various embodiments of the invention, it should be noted that the term “adoption” is defined as transferring out a projection-mapped object visualized in a projection-mapping environment to a user-specific and separate MR environment, which is operated by the user's separate electronic device even during the user's visualization of the projection-mapping environment on a large projection screen operated by the MR theme park system.

For example, the user may invoke adoption of an orca calf (i.e. a projection-mapped object) displayed in a projection-mapping environment (i.e. representing an underwater ocean ecosystem) by using a “pull” gesture command on the orca calf shown on the projection screen. In this example, the transfer-out or “adoption” of this particular projection mapped object (i.e. the orca calf) from the projection-mapping environment to the user-specific and separate MR environment is completed when the orca calf is “pulled out” from the projection screen, and then newly appears in the user's smart phone display screen executing an animal adoption interface.

Continuing with the operation flowchart (1100) of FIG. 11, after the gesture command or another user-initiated command for the adoption of the projection-mapped object to the user-specific MR environment is received in STEP 1101, the MR theme park system is configured to transmit graphical attributes and underlying metadata of the projection-mapped object to the user-specific MR environment for user adoption of the projection-mapped object, as shown in STEP 1102. In the preferred embodiment of the invention, the MR theme park system utilizes the projection-mapped object to MR holographic object adoption interface (i.e. 901 in FIG. 9), the projection-mapping environment generation server (i.e. 805 in FIG. 9), and the user-specific MR environment visualization module (i.e. 819 in FIG. 9) to coordinate the object adoption process from the projection-mapping environment to the user-specific MR environment, as previously illustrated and described in conjunction with FIGS. 8˜9.

Then, as shown in STEP 1103, the environmental transition graphical synthesis module (i.e. 905 in FIG. 9) incorporated in the projection-mapped object and MR holographic object transfer accommodation module (i.e. 807 in FIGS. 8˜9) in the MR theme park system is able to generate environmental transition graphics for the projection-mapped object undergoing user adoption. For example, the environmental transition graphics may be the projection-mapped object gradually popping out of the projection screen as a hologram, which is no longer visible on the flat two-dimensional plane of the projection screen itself. The environmental transition graphics are then displayed in the user-specific MR environment in the user's MR headset or her mobile device screen, as shown in STEP 1104.

The newly-adopted object now resides in the domain of the user-specific MR environment, and the visualization of the previously projection-mapped and adopted-out object is disabled on the projection screen. Furthermore, once the object adoption process is completed, the MR theme park system can suspend any attempts to make changes to the “adopted-out” projection-mapped object from the projection-mapping environment, as the adopted-out object is now in the exclusive control of the user in the user-specific MR environment executed on the user's personal electronic device, as shown in STEP 1105. Subsequently, the MR theme park system enables update and change authorizations to the newly-adopted object only in the user-specific MR environment executed on the user's personal electronic device, as shown in STEP 1106.

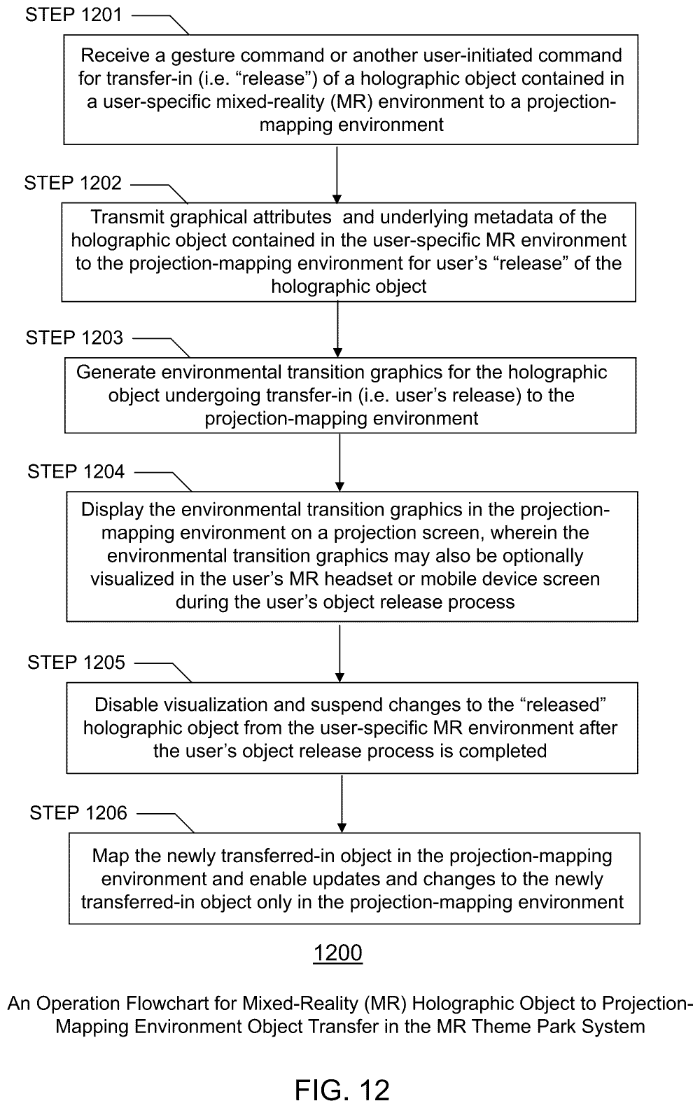

FIG. 12 shows an operation flowchart (1200) for a mixed-reality (MR) holographic object to projection-mapping environment object transfer process in a mixed-reality (MR) theme park system, in accordance with an embodiment of the invention. To initiate a transfer-in or a “release,” the MR theme park system receives a gesture command or another user-initiate command for the release of a holographic object contained in a user-specific MR environment to a projection-mapping environment, as shown in STEP 1201. In context of various embodiments of the invention, it should be noted that the term “release” is defined as “transferring in” a user's mixed-reality (MR) holographic object stored in the user's separate and personal electronic device to a projection-mapping environment operated by a mixed-reality (MR) theme park system. In one example, the user's “push” gesture of a hologram managed by the user-specific MR environment into a projection screen may indicate the transfer-in or the “release” of a user-selected object.

In the preferred embodiment of the invention, the transfer-in, or “release” of the user's MR holographic object is initiated if the user selects and invokes the release of the holographic object to the projection-mapping environment. For example, by utilizing a gesture command (e.g. pushing a selected hologram into the projection screen) over the projection screen or a mobile app user interface, the user may invoke the release of an orca calf from the user's separate and personal electronic device to a simulated wildlife environment (i.e. the projection-mapping environment) of the underwater ocean ecosystem displayed on a projection screen by the MR theme park system. In this example, the orca calf may have been previously adopted by the user from the MR theme park system, or may have been a user's native holographic pet. From a visualization perspective, the release of the orca calf can be considered to be completed when the orca calf appears in the simulated wildlife environment (i.e. the projection-mapping environment) of the underwater ocean ecosystem on the projection screen controlled by the MR theme park system, while the user's separate and personal electronic device relinquishes a direct control of the released orca calf.

Continuing with the operation flowchart (1200) of FIG. 12, after the gesture command or another user-initiated command for the release (i.e. transfer-in) of the holographic object contained in the user-specific MR environment to the projection-mapping environment is received in STEP 1201, the MR theme park system is configured to transmit graphical attributes and underlying metadata of the holographic object contained in the user-specific MR environment to the projection-mapping environment as part of the process for the user's “release” of the holographic object, as shown in STEP 1202. In the preferred embodiment of the invention, the MR theme park system utilizes the MR holographic object to projection-mapping environment object transfer interface (i.e. 903 in FIG. 9), the user-specific MR environment visualization module (i.e. 819 in FIG. 9), and the projection-mapping environment generation server (i.e. 805 in FIG. 9) to coordinate the object release process from the user-specific MR environment to the projection-mapping environment, as previously illustrated and described in conjunction with FIGS. 8˜9.

Then, as shown in STEP 1203, the environmental transition graphical synthesis module (i.e. 905 in FIG. 9) incorporated in the projection-mapped object and MR holographic object transfer accommodation module (i.e. 807 in FIGS. 8˜9) in the MR theme park system is able to generate environmental transition graphics for the holographic object undergoing user release. For example, the environmental transition graphics may be the holographic object gradually blending into the projection screen as a projection-mapped object which is no longer visible on the empty space in front of the projection screen, but is instead projected on the flat two-dimensional plane of the projection screen itself. The MR theme park system can display such environmental transition graphics in the projection-mapping environment on a projection wall or screen, and similar transition graphics may also be optionally visualized in the user's MR headset or mobile device screen during the user's object release process, as shown in STEP 1204.

The newly-released object now resides in the domain of the projection-mapping environment controlled by the MR theme park system, and the visualization of the previously holographic object in the domain of the user-specific MR environment is now disabled from the user's personal electronic device. Furthermore, once the object release process is completed, the MR theme park system can suspend any attempts to make changes to the released object from the user-specific MR environment, as the user-released and transferred-in object is now in the exclusive control of the projection-mapping environment controlled by the MR theme park system, as shown in STEP 1205. Subsequently, the MR theme park system can map the newly transferred-in object in the projection-mapping environment and enable updates and changes to the newly transferred-in object only in the projection-mapping environment, as shown in STEP 1206.

Various embodiments of a mixed-reality theme park system and related methods of operating such a system described herein provide significant and unique advantages to conventional projection-mapping applications and conventional physical theme park visits. For example, one advantage of the mixed-reality theme park system and a method of operating thereof is enabling a novel interactive projection-mapped visualization that can project desired moving images of environments and objects on a large surface at a targeted location (e.g. a large vertical wall, a sidewall of a building, etc.), wherein the projected moving images of objects can be transferred out (i.e. “popped out”) of the projection-mapping environment to become three-dimensional (3D) holograms in a mixed-reality (MR) environment operated by a user's separate and personal electronic device (e.g. an MR headset, a smart phone, etc.).

Furthermore, another advantage of the mixed-reality theme park system and the method of operating thereof is providing seamless transfers of synthetic graphical objects between a projection-mapping environment and a mixed-reality environment operated by a user's separate and personal electronic device during the user's visualization of the projection-mapping environment on a large surface at a targeted location.

Moreover, another advantage of the mixed-reality theme park system and the method of operating thereof is providing a seamless bilateral user interactivity with a projected environment and objects displayed on a large surface at a targeted location by capturing, tracking, and reacting to defined user gestures or other user-activated commands in front of the projected environment and objects.

In addition, another advantage of the mixed-reality theme park system and the method of operating thereof is providing an immersive mixed-reality theme park environment by projecting a user-selected thematic environment and objects on a large surface at a targeted location, and by accommodating seamless bilateral user interactivity and object transfers between a projection-mapping environment and a mixed-reality environment operated by the user's separate electronic device.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the claims.

What is claimed is:

1. A method of operating a mixed-reality (MR) theme park system, the method comprising the steps of:
capturing or retrieving multimedia data to be utilized in a projection-mapping environment;
identifying and separating mapped objects from background projection images in the multimedia data by utilizing a projection-mapped object and background image separation module executed in a visualization graphics processing module of the MR theme park system;
storing the mapped objects and the background projection images separately in a projection-mapping environment generation server, which is a component of the visualization graphics processing module in the MR theme park system;
projecting the mapped objects and the background projection images on a projection screen as the projection-mapping environment via a projector unit that integrates a user gesture command-tracking and user movement-tracking sensor, wherein the projector unit is incorporated into the MR theme park system;
with the user gesture command-tracking and user movement-tracking sensor integrated in the projector unit, tracking and recording gesture interactions between a user and each mapped object projected on the projection screen;
providing a visual synchronization of a user-selected mapped object transferring to or out of the projection-mapping environment and a user-specific mixed-reality (MR) environment based on a user's gesture command interpreted by the user gesture command-tracking and user movement-tracking sensor integrated into the projector unit, wherein the user-specific MR environment is executed by the user's personal electronic device independent from the projection-mapping environment;
providing an underlying data and metadata synchronization of the user-selected mapped object transferring to or out of the projection-mapping environment and the user-specific MR environment; and
enabling the user's mixed-reality (MR) headset device to visualize environmental transition graphics occurring between the projection-mapping environment on the projection screen and the user-specific MR environment outside of the projection screen, wherein the environmental transition graphics are a visual confirmation of an execution of the user's gesture command to transfer the user-selected mapped object.

2. The method of claim 1, wherein the user's gesture command in the step of providing the visual synchronization of the user-selected mapped object transferring to or out of the projection-mapping environment and the user-specific mixed-reality (MR) environment is a “pull” gesture of the user-selected mapped object out of the projection screen and indicates a transfer-out or an “adoption” of the user-selected mapped object from the projection-mapping environment to the user-specific MR environment.

3. The method of claim 2, wherein the environmental transition graphics for the transfer-out or the “adoption” of the user-selected mapped object is a gradual popping out of the user-selected mapped object from the projection screen and a transformation into a three-dimensional hologram in front of the projection screen.

4. The method of claim 1, wherein the user's gesture command in the step of providing the visual synchronization of the user-selected mapped object transferring to or out of the projection-mapping environment and the user-specific mixed-reality (MR) environment is a “push” gesture of the user-selected mapped object from the user-specific MR environment into the projection screen and indicates a transfer-in or a “release” of the user-selected mapped object from the user-specific MR environment to the projection-mapping environment.

5. The method of claim 4, wherein the environmental transition graphics for the transfer-in or the “release” of the user-selected mapped object is a gradual blending-in and transformation of the user-selected mapped object from a three-dimensional hologram in front of the projection screen to a two-dimensional flat object projected on the projection screen.

6. The method of claim 1, wherein the underlying data and metadata synchronization of the user-selected mapped object during transfer from one environment to another includes an object name, an object creation or edit date, object ownership information, object edit authorization information, object format, and object graphics resolution.

7. The method of claim 1, wherein the user gesture command-tracking and user movement-tracking sensor integrated in the projector unit is a camera, an infrared sensor, a movement sensor, a radar, a laser-based movement detector, or any combination thereof.

8. The method of claim 1, wherein the projection-mapping environment represents a computer graphics-simulated thematic landscape including at least one of a mountainous habitat, a desert ecosystem, an oceanic underwater environment, an iceberg, or an outer space.

9. The method of claim 1, wherein the user-specific MR environment executed by the user's personal electronic device independent from the projection-mapping environment is controlled through a mobile application accessible from the user's personal electronic device.
